(19) United States
(12) Patent Application Publication
(10) Pub. No.: US 2024/0428556 A1
(43) Pub. Date: Dec. 26, 2024

(54) METHOD AND APPARATUS FOR ESTIMATING A DISTANCE OF AN OBJECT BASED ON A STATIC OBJECT AND A DIFFERENCE IN GROUND HEIGHT

(71) Applicants: HYUNDAI MOTOR COMPANY, Seoul (KR); KIA CORPORATION, Seoul (KR)

(72) Inventors: Jung Won Lee, Seoul (KR); Jun Sik An, Seoul (KR)

(73) Assignees: HYUNDAI MOTOR COMPANY, Seoul (KR); KIA CORPORATION, Seoul (KR)

(21) Appl. No.: 18/507,863

(22) Filed: Nov. 13, 2023

(30) Foreign Application Priority Data
Jun. 22, 2023 (KR) 10-2023-0080497

(51) Int. Cl. G06V 10/74; G06T 7/20; G06V 10/25; G06V 20/56

(52) U.S. Cl. CPC G06V 10/761; G06T 7/20; G06V 10/25; G06V 20/588; G06V 2201/07

(57) ABSTRACT

A method and an apparatus estimate a distance of an object based on a static object and a difference in ground height. The method includes processing an image captured by an image capture means to obtain an object recognition result for an object and a space recognition result for a space. The method includes detecting a static object on a first ground higher than a second ground of a host vehicle based on the object recognition result and the space recognition result. The method includes estimating a height of the first ground based on the static object and includes estimating a distance value of the object included in the object recognition result based on the height of the first ground.

### CROSS-REFERENCE TO RELATED APPLICATION

This application claims the benefit of priority to Korean Patent Application No. 10-2023-0080497, filed in the Korean Intellectual Property Office on Jun. 22, 2023, the entire contents of which are incorporated herein by reference.

### TECHNICAL FIELD

The present disclosure relates to technologies of estimating a distance of an object. More particularly, the present disclosure relates to a method and an apparatus for estimating a distance of an object recognized from an image based on a static object on the ground higher than the ground of a host vehicle and a difference in ground height.

### BACKGROUND

With the development of vehicle electronic technology, technologies for assisting a driver to drive or replacing the driving of the driver in an existing collision detection system or the like and a recent autonomous vehicle have gradually increased. The most basic prerequisite for the use of these technologies is to detect objects, which are present around the vehicle. Research and development thereof have been conducted.

Furthermore, various types of driver assistance systems based on image technologies have been developed. Particularly, an object in front of a vehicle and a distance from the object are used to support safe driving in a situation where the concentration of a driver is reduced, as well as during autonomous driving.

A technology in an existing embodiment for estimating a distance from an object estimates the distance from the object assuming that the ground height of the host vehicle and the ground height of the object are identical to each other. However, because it is assumed in the existing technology that the ground height of the host vehicle and the ground height of the object are identical to each other, a distance estimation value of the object on a place higher than the ground of the host vehicle, for example, a curb or the like may be degraded in accuracy.

### SUMMARY

Thus, there is a need for a method capable of accurately estimating a distance from an object on the ground, which differs in height from the ground of the host vehicle.

The present disclosure has been made to solve the above-mentioned problems occurring in the prior art while advantages achieved by the prior art are maintained intact.

Aspects of the present disclosure provide a method and an apparatus for estimating a distance of an object recognized from an image based on a static object on the ground higher than the ground of a host vehicle and a difference in ground height.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, a method for estimating a distance of an object is provided. The method may include processing an image captured by an image capture means to obtain an object recognition result for an object and a space recognition result for a space. The method may also include detecting a static object on a first ground higher than a second ground of a host vehicle based on the object recognition result and the space recognition result. The method may also include estimating a height of the first ground based on the static object. The method may also include estimating a distance value of the object included in the object recognition result based on the height of the first ground.

According to an embodiment, estimating the height of the first ground may include estimating the height of the first ground based on a difference in time between consecutive frames captured by the image capture means, a distance of the static object in each of the consecutive frames, and a speed of the host vehicle.

According to an embodiment, estimating the height of the first ground may include calculating a relative speed of the static object based on the difference in time between the consecutive frames and the speed of the host vehicle. Estimating the height of the first ground may also include estimating the height of the first ground based on a difference in distance of the static object between the consecutive frames and the relative speed.

According to an embodiment, detecting the static object may include determining a curb area where there is a curb by means of the space recognition result, when the first ground is a ground of the curb. Detecting the static object may also include detecting the static object based on the curb area and a position of the curb.

According to an embodiment, detecting the static object may include detecting the object as an object presenting in the curb area, when a center point of a lower end of a bounding box of the object recognition result is present in the curb area. Detecting the static object may also include detecting the static object among the detected objects.

According to an embodiment, detecting the static object may include determining whether a vehicle is on the curb area based on a result of recognizing a wheel of the vehicle, when the object is the vehicle.

According to an embodiment, detecting the static object may include detecting a predetermined static object presenting on the first ground using a classifier.

According to an embodiment, detecting the static object may include detecting objects on the first ground based on the object recognition result and the space recognition result for each of consecutive frames captured by the image capture means. Detecting the static object may also include calculating a relative speed of each of the objects based on a difference in time between the consecutive frames, a distance of each of the objects in each of the consecutive frames, and a speed of the host vehicle. Detecting the static object may also include detecting the static object based on the calculated relative speed.

According to an embodiment, estimating the distance value of the object may include reflecting the height of the first ground to estimate the distance value of the object, when the object is an object on the first ground.

According to another aspect of the present disclosure, an apparatus for estimating a distance of an object is provided. The apparatus may include a recognition device configured to process an image captured by an image capture means to obtain an object recognition result for an object and a space recognition result for a space. The apparatus may also include a detection device configured to detect a static object on a first ground higher than a second ground of a host vehicle based on the object recognition result and the space recognition result. The apparatus may also include an estimation device configured to estimate a height of the first ground based on the static object and estimate a distance value of the object included in the object recognition result based on the height of the first ground.

According to an embodiment, the estimation device may estimate the height of the first ground based on a difference in time between consecutive frames captured by the image capture means, a distance of the static object in each of the consecutive frames, and a speed of the host vehicle.

According to an embodiment, the estimation device may calculate a relative speed of the static object based on the difference in time between the consecutive frames and the speed of the host vehicle. The estimation device may also estimate the height of the first ground based on a difference in distance of the static object between the consecutive frames and the relative speed.

According to an embodiment, the detection device may determine a curb area where there is a curb by means of the space recognition result, when the first ground is a ground of the curb. The detection device may also detect the static object based on the curb area and a position of the curb.

According to an embodiment, the detection device may detect the object as an object presenting on the curb area, when a center point of a lower end of a bounding box of the object recognition result is present on the curb area. The detection device may also detect the static object among the detected objects.

According to an embodiment, the detection device may determine whether a vehicle is on the curb area based on a result of recognizing a wheel of the vehicle, when the object is the vehicle.

According to an embodiment, the detection device may detect a predetermined static object presenting on the first ground using a classifier.

According to an embodiment, the detection device may detect objects on the first ground based on the object recognition result and the space recognition result for each of consecutive frames captured by the image capture means. The detection device may also calculate a relative speed of each of the objects based on a difference in time between the consecutive frames, a distance of each of the objects in each of the consecutive frames, and a speed of the host vehicle. The detection device may also detect the static object based on the calculated relative speed.

According to an embodiment, the estimation device may reflect the height of the first ground to estimate the distance value of the object, when the object is an object on the first ground.

The features briefly summarized above with respect to the present disclosure are merely example aspects of the detailed description of the present disclosure, which is described below, and do not limit the scope of the present disclosure.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates an operational flowchart of a method for estimating a distance of an object according to an embodiment of the present disclosure;

FIG. 2 illustrates an operational flowchart of an embodiment of S140 of FIG. 1;

FIGS. 3A, 3B, and 3C illustrate drawings of examples of an input image, an object recognition result for the input image, and a space recognition result for the input image;

FIG. 4 illustrates a drawing of an example for describing a process of detecting a static object on a curb;

FIG. 5 illustrates a drawing of an example for describing a process of estimating a distance of an object located on the same ground as a host vehicle;

FIG. 6 illustrates a drawing of an example for describing a process of estimating a height of a curb and estimating a distance of an object using the height of the curb;

FIG. 7 illustrates a block diagram of an apparatus for estimating a distance of an object according to another embodiment of the present disclosure; and

FIG. 8 illustrates a block diagram of a computing system for executing a method for estimating a distance of an object according to an embodiment of the present disclosure.

### DETAILED DESCRIPTION

Hereinafter, embodiments of the present disclosure are described more fully with reference to the accompanying drawings to such an extent as to be understood by one having ordinary skill in the art. However, the present disclosure may be embodied in many different forms and should not be construed as being limited to the embodiments set forth herein.

In describing an embodiment of the present disclosure, where it has been determined that a detailed description of a well-known configuration or function may obscure the gist of the present disclosure, a detailed description thereof has been omitted. Parts not related to the description of the present disclosure have been omitted in the drawings. Similar parts are denoted by similar reference numerals throughout the specification.

In the present disclosure, when one component is referred to as being “connected with” or “coupled to” another component, it includes not only a case where the component is directly connected but also a case where the component is indirectly connected with another component with other devices in between. In addition, when one component is referred to as “comprising”, “including” or “having” another component, it is meant that the component may further include other components without excluding other components as long as there is no contrary description.

In the present disclosure, the terms such as “first” and “second” are used only for the purpose of distinguishing one component from another but do not limit an order, the importance, or the like of components unless specifically stated. Thus, a first component in an embodiment may be referred to as a second component in another embodiment in the scope of the present disclosure. Likewise, a second component in an embodiment may be referred to as a first component in another embodiment.

In the present disclosure, components, are which distinguished from each other, are only for clearly explaining each feature, and the components are not necessarily separated. In other words, a plurality of components may be integrated to form a single hardware or software unit, or a single component may be distributed to form a plurality of hardware or software units. Thus, even if not specifically mentioned, the integrated or separate embodiments are also included in the scope of the present disclosure.

In the present disclosure, components described in various embodiments may not necessarily refer to essential components, some thereof may be selective components. Thus, an embodiment composed of a subset of components described in an embodiment is also included in the scope of the present disclosure. Thus, an embodiment which additionally includes another component in components described in various embodiments is also included in the scope of the present disclosure.

In the present disclosure, expressions of positional relationships used in the specification, such as for example, top, bottom, left, and right, are described for convenience of description. When viewing the drawings illustrated in the specification in reverse, the positional relationship described in the specification may be interpreted in the opposite way.

In the present disclosure, each of the phrases, such as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

Embodiments of the present disclosure aim to improve the accuracy of estimating a distance of an object located on the ground (for example, a curb), which differs in height from the ground of a host vehicle. A distance of an object located on the curb may be accurately estimated based on a static object located on the curb and a height of the curb. As used herein, the term “ground” is used generically to define a surface supporting or underlying objects, and may include a curb surface, a road surface, a dirt or earthen surface, or the like.

Hereinafter, in an embodiment of the present disclosure, the ground higher than the ground of the host vehicle may vary. However, for convenience of description, the ground higher than the ground of the host vehicle is described as being limited to the ground or surface of a curb. Although a method and an apparatus of the present disclosure are described as being limited to a curb, the method and the apparatus of the present disclosure may be applied to estimate distances of objects located on various grounds or surfaces higher than the ground of the host vehicle, i.e., the surface on which the host vehicle resides.

In addition, embodiments of the present disclosure may process an image captured by an image capture device, for example, a camera, attached to a vehicle to obtain an object recognition result and a space recognition result. The embodiments may also detect a static object on a curb based on the object recognition result and the space recognition result. The embodiments may also estimate a height of the curb with respect to the detected static object, information about consecutive frames (e.g., a difference in time between the frames, or the like), a speed of a host vehicle, or the like. Thus, the height of the curb is used to accurately estimate a distance of the object on the curb.

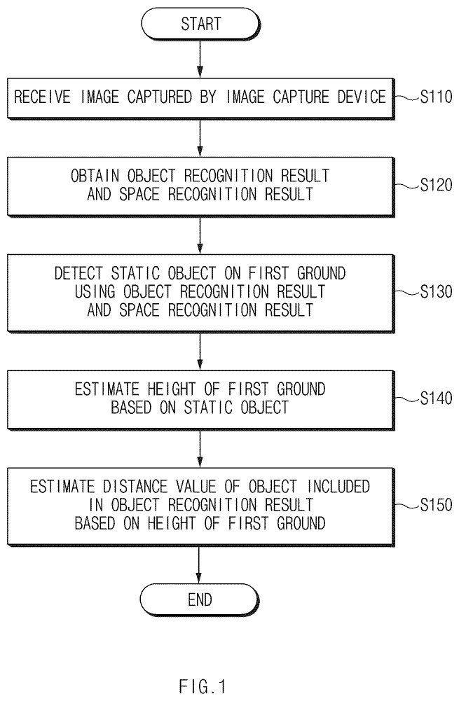

Hereinafter, a method and an apparatus according to an embodiment of the present disclosure are described with reference to FIGS. 1-8.

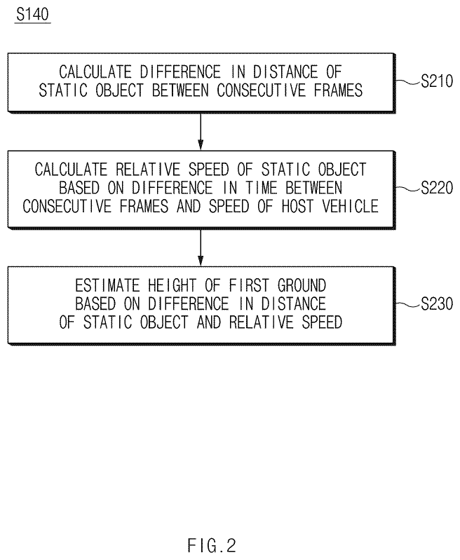

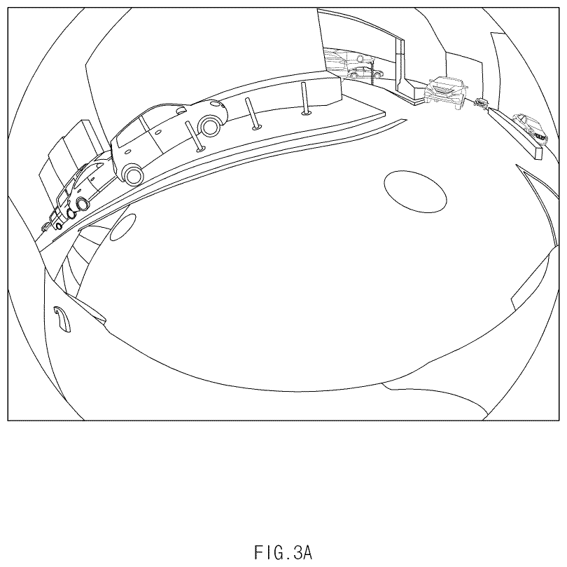

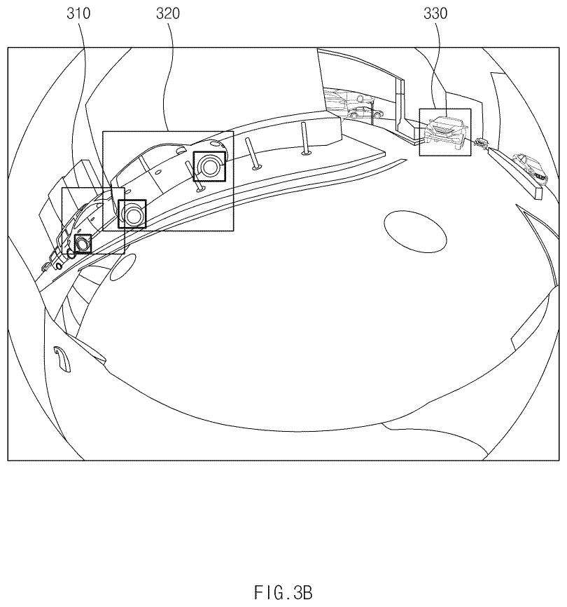

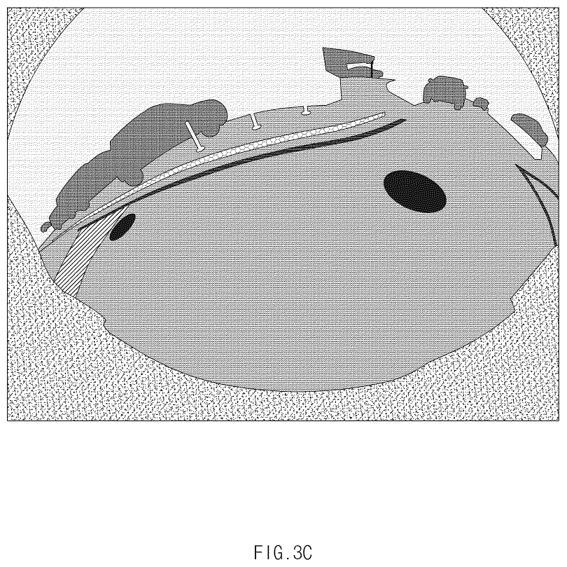

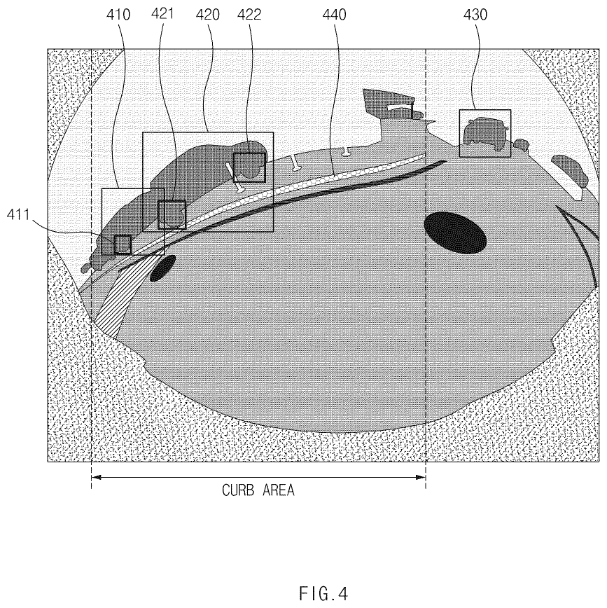

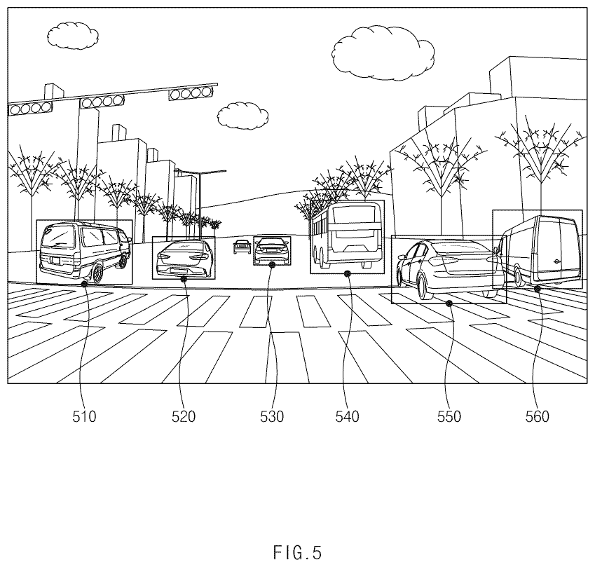

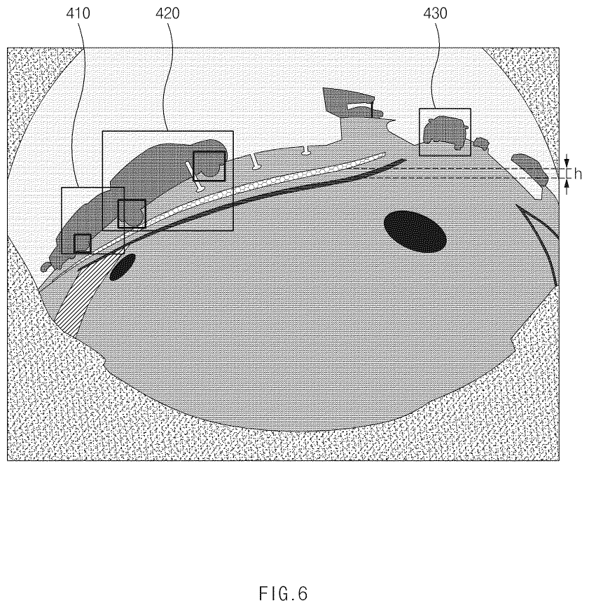

FIG. 1 illustrates an operational flowchart of a method for estimating a distance of an object according to an embodiment of the present disclosure. FIG. 2 illustrates an operational flowchart of an embodiment of S140 of FIG. 1. FIGS. 3A, 3B, and 3C illustrate drawings of examples of an input image, an object recognition result for the input image, and a space recognition result for the input image. FIG. 4 illustrates a drawing of an example for describing a process of detecting a static object on a curb. FIG. 5 illustrates a drawing of an example for describing a process of estimating a distance of an object located on the same ground as a host vehicle. FIG. 6 illustrates a drawing of an example for describing a process of estimating a height of a curb and estimating a distance of an object using the height of the curb.

Referring to FIG. 1, in S110, the method for estimating the distance of an object according to an embodiment of the present disclosure may capture an image by means of an image capture device, such as a camera loaded into or attached to a vehicle, for example, a host vehicle, to receive the image captured in real time by the image capture device.

Herein, in S110, frames (or images) consecutively captured by the image capture device may be received. The image capture device may consecutively capture an image at a predetermined frame rate. An embodiment of the present disclosure may use a difference in time between such frames.

When the image is received in S110, in S120, the received image may be processed to obtain (or output) an object recognition result for an object included in the image and a space recognition result for a space included in the image.

According to an embodiment, in S120, the image may be input to a pre-trained deep learning-based artificial intelligence network (e.g., an object recognition artificial intelligence network) for detecting an object to obtain the result of recognizing the object included in the image. The image may be input to a pre-trained deep learning-based artificial intelligence network (e.g., a space recognition artificial intelligence network) for detecting a space to obtain the result of recognizing the space included in the image. The object recognition artificial intelligence network may be a network, which outputs a position and a class of a thing as a bounding box. The space recognition artificial intelligence network may be a network, which matches class information with a pixel.

In an embodiment of the present disclosure, the scheme, which obtains the object recognition result and the space recognition result, is not limited or restricted to the artificial intelligence. All schemes for detecting an object from an image and all schemes for detecting a space from an image may be applied.

When the result of recognizing the object included in the image and the result of recognizing the space included in the image are obtained in S120, in S130, a static object on a first ground (for example, the ground or surface of the curb) higher than the ground of the host vehicle may be detected using the object recognition result and the space recognition result.

According to an embodiment, in S130, a curb area where there is the curb may be determined by using the object recognition result and the space recognition result. Objects on the curb may be detected based on the curb area and the position of the curb to detect the static object among the detected objects.

As an example, in S130, at least one predetermined static object on the curb may be detected by using a pre-trained deep learning-based classifier, for example, a class classifier. As another example, in S130, objects on the curb may be detected based on the object recognition result and the space recognition result for each of consecutive frames captured by the image capture means or device, because a predetermined static object is unable to be detected by the classifier. A relative speed of each of the objects may be calculated based on a difference in time between the frames, a distance (or a difference in distance) of each of the objects in each of the frames, and a speed of the host vehicle. The static object on the curb may be detected based on the relative speed of each of the objects. The scheme may be a scheme configured to detect an object with a relative speed for the speed of the host vehicle as the static object. When the scheme is used, a vehicle, a motorcycle, or the like parked on the curb may be detected as the static object. Of course, the method according to an embodiment of the present disclosure may use each of the above-mentioned two schemes, may use the above-mentioned two schemes in parallel, and may use the above-mentioned second scheme when the static object is not detected by the class classifier.

When the static object on the curb is detected in S130, in S140 and S150, the height of the first ground, i.e., the height of the curb, may be estimated based on the detected static object, and a distance value of the object included in the object recognition result may be estimated based on the estimated height of the curb.

According to an embodiment, in S140, the height of the curb may be estimated based on the difference in time between the consecutive frames captured by the image capture means, a distance (or a difference in distance) of the static object in each of the frames, and the speed of the host vehicle.

According to an embodiment, as shown in FIG. 2, in S210 of S140, a difference in distance between the frames for the static object included in each of the consecutive frames captured by the image capture means may be calculated.

Herein, the difference in distance for the same static object between the frames may be expressed as a height of a curb to be estimated. Thus, S210 may be a portion of a process of estimating the height of the curb.

When the difference in distance for the static object between the consecutive frames is calculated in S210, in S220 and S230, a relative speed of the static object may be calculated based on the difference in time between the consecutive frames. The speed of the host vehicle and the height of the first ground, i.e., the height of the curb, may be estimated based on the calculated relative speed of the static object and the difference in distance of the static object between the consecutive frames.

Depending on a situation, S210 and S220 may be sequentially performed, may be performed in parallel, or an order where S210 and S220 are performed may be reversely performed.

A description is given in detail of the above-mentioned method for estimating the object distance according to an embodiment of the present disclosure with reference to FIGS. 3A-6.

When an image (or a frame) captured by a camera is received as in an example shown in FIG. 3A, the method for estimating the distance to an object according to an embodiment of the present disclosure may process an input image to detect objects included in the image, such as for example, vehicles as shown in FIG. 3B. Thus, object recognition results 310, 320, and 330 expressed with bounding boxes may be obtained. Herein, the object recognition result may also be detected by a pre-trained artificial intelligence network for recognizing an object.

Next, the method of the present disclosure may obtain a space recognition result, for example, a space recognition result as shown in FIG. 3C, for the input image of FIG. 3A by means of a device or an artificial intelligence network, which performs space recognition in the input image.

When the object recognition result of FIG. 3B and the space recognition result of FIG. 3C are obtained, the method of the present disclosure may detect a curb area where there is a curb 440, as in an example shown in FIG. 4, using the object recognition result and the space recognition result. The method of the present disclosure may also detect objects 410 and 420, which are located in the curb area and are on the curb 440, based on the position of the curb 440 among objects 410, 420, and 430 included in the object recognition result. Herein, because the objects 410 and 420 on the curb 440 may be static objects and dynamic objects, the method of the present disclosure should determine whether the detected object is a dynamic object or a static object.

At this time, when a center point of a lower end of a bounding box of the object recognition result is present in the curb area of the space recognition result, the method of the present disclosure may determine whether the object is present in the curb area. When the object is a vehicle, the method of the present disclosure may determine whether the object is present in the curb area based on the result of recognizing a wheel of the vehicle. For example, as shown in FIG. 4, the method of the present disclosure may determine the first object 410 as an object, which is present in the curb area, because a wheel area 411 of the first object 410 is located in the curb area based on the result of recognizing the wheel of the vehicle. The method of the present disclosure may also determine the second object 420 as an object, which is present in the curb area, because wheel areas 421 and 422 of the second area 420 are located in the curb area.

According to an embodiment, the method of the present disclosure may detect predetermined static objects, for example, a street lamp, a tree, a sign, and the like using a class classifier to detect the static objects, which are present on the curb.

According to an embodiment, because the above-mentioned static objects are unable to be detected by the class classifier depending on a situation, the method of the present disclosure may detect an object with a relative speed with respect to the speed of the host vehicle as the static object, using a difference in time between consecutive frames, the speed of the host vehicle, a distance between objects, which are present on the curb detected from each of the consecutive frames, and the like. For example, the method of the present disclosure may detect both the first object 410 and the second object 420 as static objects, when the first object 410 and the second object 420 are determined as objects, each of which has a relative speed with respect to the speed of the host vehicle. However, the method of the present disclosure may determine the first object 410 as a dynamic object and determine only the second object 420 as a static object, when only the second object 420 is determined as an object with a relative speed with respect to the speed of the host vehicle.

Because the detected object has an error generated by a height of the curb due to the height of the curb when the distance is calculated in an existing distance estimation method, the method of the present disclosure may estimate a height of the curb and correct a distance of the object using the estimated height of the curb to correct a distance error capable of being generated by the height of the curb. Thus, the accuracy of estimating the distance of the object on the curb may be improved.

When the static object on the curb is detected via the above-mentioned process, the method of the present disclosure may estimate a height (h of FIG. 6) of the curb based on the detected static object (e.g., at least one of the first object 410 or the second object 420 of FIG. 6), the speed of the host vehicle, a difference in time between consecutive frames, and the distance of the static object included in each of the consecutive frames. Because the distance value of the static object may be expressed as an equation including the height h of the curb, a difference in distance of the static object included in the consecutive frames, such as for example, a distance of a first static object in a first frame and a distance of the first static object in a second frame, may also be expressed as an equation including the height h of the curb. The relative speed of the static object is able to also be expressed as an equation including the height h of the curb and the method of the present disclosure may calculate the height h of the curb using the equations expressed as the height h of the curb. Thus, the height h of the curb may be accurately estimated.

For example, the distance of the object by the existing object distance estimation scheme may be calculated by Equation 1 below.

$$[ Equation 1 ]$$

$$s [ \begin{matrix}x \\ y \\ 1\end{matrix} ] = [ \begin{matrix}K & R & T\end{matrix} ] [ \begin{matrix}X \\ Y \\ Z \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] ,$$

$$x = \frac{{a}_{1} X + {a}_{2} Y + {a}_{3} Z + {a}_{4}}{s}$$

$$y = \frac{{b}_{1} X + {b}_{2} Y + {b}_{3} Z + {b}_{4}}{s}$$

Herein, s may refer to the scaling factor, K may refer to the camera matrix including the camera internal parameter, R may refer to the rotation matrix or the rotation transformation matrix, and T may refer to the linear transformation matrix or the movement vector matrix. Furthermore, fₓ and f_{y} may refer to the two different focal distances, and cx and Cy may refer to the optical centers of the camera. Furthermore, a₁, a₂, a₃, a₄, b₁, b₂, b₃, and b₄ may refer to the coefficients and the constants of X, Y, and Z, when the matrix of Equation 1 above is calculated.

As seen from Equation 1 above, the camera matrix and the rotation matrix or the rotation transformation matrix may be represented as a matrix for transforming a camera coordinate system into an image coordinate system and a matrix for transforming a world coordinate system into a camera coordinate system.

Equation 1 above indicates a point correspondence relationship on a 3D space and a 2D space. It may not be seen that coordinates on the image correspond to any 3D point. However, when a coordinate value on one axis at a 3D correspondence point is known, a coordinate value on another axis may also be known. Assuming that the center portion of the lower end of the bounding box is a portion where the object is in contact with the ground according to the object recognition result, as a Z-axis value of a corresponding point becomes “0”, an X and Y value in three dimensions, i.e., a distance value of the object, may be derived using Equation 1 above. For example, as shown in FIG. 5, because a center portion 510, 520, 530, 540, 550, or 560 of the lower end of the bounding box of each object detected according to the object recognition result is in contact with the same ground as the ground of the host vehicle, Z may be set to “0” in Equation 1 above and a distance value of each object may be estimated.

On the other hand, because an object on the curb is located on the ground with a height different from the ground of the host vehicle, Z in Equation 1 above may indicate the height h of the curb and this may be represented as Equation 2 below.

$$[ Equation 2 ]$$

$$s [ \begin{matrix}x \\ y \\ 1\end{matrix} ] = [ \begin{matrix}K & R & T\end{matrix} ] [ \begin{matrix}X \\ Y \\ Z \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

$$x = \frac{{a}_{1} X + {a}_{2} Y + {a}_{3} h + {a}_{4}}{s}$$

$$y = \frac{{b}_{1} X + {b}_{2} Y + {b}_{3} h + {b}_{4}}{s}$$

The height h of the curb should be estimated to estimate the distance value of the object on the curb by means of Equation 2 above. The height h of the curb may be estimated based on the static object, the speed of the host vehicle, the difference in time between the consecutive frames, and the distance (or the difference in distance) of the static object included in each of the consecutive frames.

To estimate a distance of the object in which the height of the curb is reflected, Equation 3 below may be derived using Equation 2 above.

$${b}_{2} sx = ( {a}_{1} X + {a}_{2} Y + {a}_{3} h + {a}_{4} ) b 2 \qquad [ Equation 3 ]$$

$${a}_{2} sx = ( {b}_{1} X + {b}_{2} Y + {b}_{3} h + {b}_{4} ) a 2$$

$${b}_{2} sx - {a}_{2} sy = {a}_{1} {b}_{2} X - {a}_{2} {b}_{1} X + {a}_{3} {b}_{2} h - {a}_{2} {b}_{3} h + {a}_{4} {b}_{2} - {a}_{2} {b}_{4}$$

$$X = \frac{( {b}_{2} sx - {a}_{s} sy ) - ( {a}_{4} {b}_{2} - {a}_{2} {b}_{4} ) - ( {a}_{3} {b}_{2} - {a}_{2} {b}_{3} ) h}{{a}_{1} {b}_{2} - {a}_{2} {b}_{1}}$$

The method of the present disclosure may estimate a relationship among X of Equation 3 above, i.e., the difference X in distance of the static object included in each frame, a speed V of the host vehicle (or a relative speed of the static object), and a difference t in time between frames, such as for example, h included in X as X=Vt. The method of the present disclosure may reflect the estimated height h of the curb in the distance value of the object on the curb. Thus, a distance value of a dynamic object or a static object on the curb without an error may be accurately estimated.

As such, the method for estimating the distance of the object according to an embodiment of the present disclosure may accurately estimate the distance of the object recognized from the image based on the static object on the ground higher than the ground of the host vehicle and the difference in ground height.

Furthermore, in estimating the distance of the object located on the curb or the like, the method for estimating the object distance according to an embodiment of the present disclosure may estimate the height of the curb based on the static object on the curb and may reflect the height of the curb to correct a distance value of the object. Thus, the accuracy of estimating the distance to the object may be improved.

Furthermore, the method for estimating the object distance according to an embodiment of the present disclosure may improve the accuracy of estimating the distance to the object located on the ground (for example, the curb), which differs in height from the ground of the host vehicle. Thus, the reliability of safe driving of the vehicle may be improved.

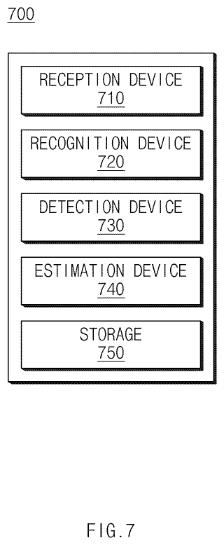

FIG. 7 illustrates a block diagram of an apparatus for estimating an object distance according to another embodiment of the present disclosure, which illustrates a conceptual block diagram of an apparatus for performing a method of FIGS. 1-6.

Referring to FIG. 7, an apparatus 700 for estimating an object distance according to another embodiment of the present disclosure may include a reception device 710, a recognition device 720, a detection device 730, an estimation device 740, and storage 750.

The storage 750 may store an image captured by a camera and an algorithm for estimating a distance of an object. The storage 750 may also store all data associated with technologies of the present disclosure, including an artificial intelligence network, a deep learning-based object recognition model, a deep learning-based space recognition model, a class classifier, or the like. Of course, the storage 750 may store all of data for estimating a height of a curb, object recognition result data, space recognition result data, and the like as well as the above-mentioned data.

The reception device 710 may receive frames (or images) consecutively captured by an image capture device, such as for example, a camera.

The recognition device 720 may process the image received through the reception device 710 to obtain an object recognition result for the image and a space recognition result for the image.

According to an embodiment, the recognition device 720 may input the image to a pre-trained deep learning-based artificial intelligence network for detecting an object to obtain the result of recognizing the object included in the image. The recognition device 720 may also input the image to a pre-trained deep learning-based artificial intelligence network for detecting a space to obtain the result of recognizing the space included in the image.

The detection device 730 may detect a dynamic object or a static object on a first surface higher than the ground of a host vehicle, for example, the ground or surface of a curb, using the object recognition result and the space recognition result obtained by the recognition device 720.

According to an embodiment, the detection device 730 may determine a curb area where there is the curb using the object recognition result and the space recognition result. The detection device 730 may also detect objects on the curb based on the curb area and the position of the curb to detect a static object among the detected objects.

According to an embodiment, the detection device 730 may detect at least one predetermined static object on the curb using a pre-trained deep learning-based classifier, such as for example, a class classifier.

According to an embodiment, the detection device 730 may detect objects on the curb based on the object recognition result and the space recognition result for each of consecutive frames captured by an image capture means. The detection device 730 also may calculate a relative speed of each of the objects based on a difference in time between the frames, a distance of each of the objects in each of the frames, and a speed of the host vehicle. The detection device 730 also may detect a static object on the curb based on the relative speed of each of the objects.

The estimation device 740 may estimate a height of the first ground, i.e., a height of the curb, based on the static object detected by the detection device 730. The estimation device 740 may also estimate a distance value of the object included in the object recognition result based on the estimated height of the curb.

According to an embodiment, the estimation device 740 may estimate a height of the curb based on the difference in time between the consecutive frames captured by the image capture means, a distance of the static object in each of the frames, and the speed of the host vehicle.

According to an embodiment, the estimation device 740 may calculate a difference in distance between the frames for the static object included in each of the consecutive frames captured by the image capture means. The estimation device 740 may also calculate a relative speed of the static object based on the difference in time between the consecutive frames and the speed of the host vehicle. The estimation device 740 may also estimate a height of the curb based on the calculated relative speed of the static object and the difference in distance of the static object between the consecutive frames.

Although descriptions of the apparatus according to other embodiments of the present disclosure have been omitted, the apparatus according to another embodiment of the present disclosure may include all contents described in the method of FIGS. 1-6. This should be apparent to those having ordinary skill in the technical field of the present disclosure.

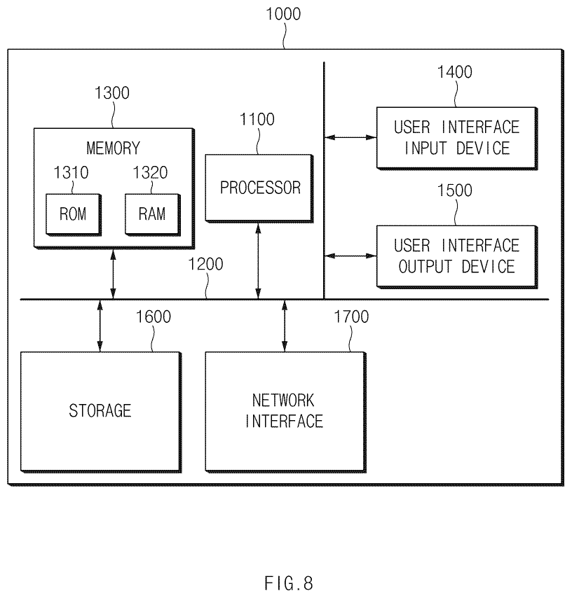

FIG. 8 illustrates a block diagram of a computing system for executing a method for estimating an object distance according to an embodiment of the present disclosure.

Referring to FIG. 8, the method for estimating the distance of an object according to an embodiment of the present disclosure may be implemented via a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600), such as a RAM, a flash memory, a ROM, an EPROM, an EEPROM, a register, a hard disc, a removable disk, and a CD-ROM. The storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

According to an embodiment of the present disclosure, the method and the apparatus may be provided to estimate the distance of the object recognized from the image based on the static object on the ground higher than the ground of the host vehicle and the difference in ground difference.

According to an embodiment of the present disclosure, the method and the apparatus may be provided to estimate a height of a curb based on a static object on the curb, in estimating a distance of an object on the curb or the like. The method and the apparatus may also reflect the height of the curb to correct a distance value of the object. The accuracy of estimating a distance to the object may be improved.

According to an embodiment of the present disclosure, the method and the apparatus may be provided to improve the accuracy of estimating a distance to an object, such as a curb, which is located on a first ground, which differs in height from the ground, i.e., a second ground of the host vehicle. Thus, the reliability of safe driving of the vehicle may be improved.

The effects that are achieved via the present disclosure may not be limited to the effects described above. Other advantages or effects not described above may be more clearly understood from the following detailed description by those having ordinary skill in the art to which the present disclosure pertains.

Hereinabove, although the present disclosure has been described with reference to embodiments and the accompanying drawings, the present disclosure is not limited thereto. The embodiments of the present disclosure may be variously modified and altered by those having ordinary skill in the art to which the present disclosure pertains without departing from the spirit and scope of the present disclosure claimed in the following claims. Therefore, embodiments described in the present disclosure are not intended to limit the technical spirit of the present disclosure. The scope of the technical spirit of the present disclosure is not limited by such embodiments. The scope of the present disclosure should be construed based on the accompanying claims. All the technical ideas within the scope equivalent to the claims should be included in the scope of the present disclosure.

What is claimed is:

1. A method for estimating a distance of an object, the method comprising:
processing an image captured by an image capture means to obtain an object recognition result for an object and a space recognition result for a space;
detecting a static object on a first ground higher than a second ground of a host vehicle based on the object recognition result and the space recognition result;
estimating a height of the first ground based on the static object; and
estimating a distance value of the object included in the object recognition result based on the height of the first ground.

2. The method of claim 1, wherein estimating the height of the first ground includes:
estimating the height of the first ground based on a difference in time between consecutive frames captured by the image capture means, a distance of the static object in each of the consecutive frames, and a speed of the host vehicle.

3. The method of claim 2, wherein estimating the height of the first ground includes:
calculating a relative speed of the static object based on the difference in time between the consecutive frames and the speed of the host vehicle; and
estimating the height of the first ground based on a difference in distance of the static object between the consecutive frames and the relative speed.

4. The method of claim 1, wherein detecting the static object includes:
determining a curb area where there is a curb by means of the space recognition result, when the first ground is a ground of the curb; and
detecting the static object based on the curb area and a position of the curb.

5. The method of claim 4, wherein detecting the static object includes:
detecting the object as an object presenting in the curb area, when a center point of a lower end of a bounding box of the object recognition result is present in the curb area; and
detecting the static object among the detected objects.

6. The method of claim 4, wherein detecting the static object includes:
determining whether a vehicle is on the curb area based on a result of recognizing a wheel of the vehicle, when the object is the vehicle.

7. The method of claim 1, wherein detecting the static object includes:
detecting a predetermined static object presenting on the first ground using a classifier.

8. The method of claim 1, wherein detecting the static object includes:
detecting objects on the first ground based on the object recognition result and the space recognition result for each of consecutive frames captured by the image capture means;
calculating a relative speed of each of the objects based on a difference in time between the consecutive frames, a distance of each of the objects in each of the consecutive frames, and a speed of the host vehicle; and
detecting the static object based on the calculated relative speed.

9. The method of claim 1, wherein estimating of the distance value of the object includes:
reflecting the height of the first ground to estimate the distance value of the object, based on that the object is an object on the first ground.

10. An apparatus for estimating a distance of an object, the apparatus comprising:
a recognition device configured to process an image captured by an image capture means to obtain an object recognition result for an object and a space recognition result for a space;
a detection device configured to detect a static object on a first ground higher than a second ground of a host vehicle based on the object recognition result and the space recognition result; and
an estimation device configured to estimate a height of the first ground based on the static object and estimate a distance value of the object included in the object recognition result based on the height of the first ground.

11. The apparatus of claim 10, wherein the estimation device is configured to estimate the height of the first ground based on a difference in time between consecutive frames captured by the image capture means, a distance of the static object in each of the consecutive frames, and a speed of the host vehicle.

12. The apparatus of claim 11, wherein the estimation device is configured to:
calculate a relative speed of the static object based on the difference in time between the consecutive frames and the speed of the host vehicle; and
estimate the height of the first ground based on a difference in distance of the static object between the consecutive frames and the relative speed.

13. The apparatus of claim 10, wherein the detection device is configured to:
determine a curb area where there is a curb by means of the space recognition result, when the first ground is a ground of the curb; and
detect the static object based on the curb area and a position of the curb.

14. The apparatus of claim 13, wherein the detection device is configured to:
detect the object as an object presenting in the curb area, when a center point of a lower end of a bounding box of the object recognition result is present in the curb area; and
detect the static object among the detected objects.

15. The apparatus of claim 13, wherein the detection device determines whether a vehicle is on the curb area based on a result of recognizing a wheel of the vehicle, when the object is the vehicle.

16. The apparatus of claim 10, wherein the detection device is configured to detect a predetermined static object presenting on the first ground using a classifier.

17. The apparatus of claim 10, wherein the detection device is configured to:
detect objects on the first ground based on the object recognition result and the space recognition result for each of consecutive frames captured by the image capture means;
calculate a relative speed of each of the objects based on a difference in time between the consecutive frames, a distance of each of the objects in each of the consecutive frames, and a speed of the host vehicle; and
detect the static object based on the calculated relative speed.

18. The apparatus of claim 10, wherein the estimation device is configured to reflect the height of the first ground to estimate the distance value of the object, when the object is an object on the first ground.
